(19) United States
(12) Patent Application Publication
(10) Pub. No.: US 2012/0069192 A1
(43) Pub. Date: Mar. 22, 2012

(54) Data Processing System and Method

(76) Inventors: Qing-Hu Li, Beijing (CN); Qiming Chen, Cupertino, CA (US); Tao Yu, Beijing (CN); Wei Liu, Beijing (CN)

(21) Appl. No.: 13/258,478

(22) PCT Filed: Oct. 20, 2009
(86) PCT No.: PCT/CN2009/074525

§ 371 Date: Nov. 16, 2011

(51) Int. Cl. H04N 7/18

(52) U.S. Cl. 348/159; 348/E07.085

(57) ABSTRACT

A data processing system and method for processing images received from multiple cameras are provided. The system includes a memory for receiving first and second images associated with respective cameras; a determiner adapted to process the first and the second images to identify respective objects depicted therein; the determiner is further adapted to calculate a predetermined metric associated with projections of the respective objects in a first frame of reference; and a labeler adapted to assign a common label to the objects according to the predetermined metric.

### BACKGROUND OF THE INVENTION

Embodiments of the present invention relate to a data processing system and method.

In the field of data processing, for example, image processing, often objects are identified and tracked by multiple cameras as they traverse the respective fields of view of those cameras. Such tracking of an object is generally a coordinated action and requires the objects to be consistently identified and labelled. Consistent labelling is a fundamental issue in multi-camera, multi-object tracking. It will be appreciated that consistent labelling requires the same object to be identified and consistently labelled across multiple different perspectives, which is a non-trivial task.

### BRIEF DESCRIPTION OF THE DRAWINGS

Embodiments of the present invention will now be described, by way of example, only, with reference to the accompanying drawings in which:

FIG. 1 shows an image plane containing an identified object;

FIG. 2 illustrates an apparatus according to an embodiment together with respective cameras;

FIG. 3 depicts a coordinate system according to embodiments of the present invention; and

FIG. 4 illustrates a flowchart for consistent labelling according to embodiments of the present invention.

### PREFERRED EMBODIMENTS

Accordingly, embodiments of the invention provide a data processing method comprising the steps of: receiving a first image from a first camera having a respective camera origin; receiving a second image from a second camera having a respective camera origin; identifying a first reference feature of a first detected object within the first image; identifying a second reference feature of a second detected object within the second image; forming a projection from the first camera origin through the first reference feature onto a common reference; forming a projection from the second camera origin through the second reference feature onto the common reference; determining a projection onto the common reference of a normal depending from a midpoint of a common perpendicular between lines segments associated with projection from the first camera origin through the first reference feature onto the common reference and the projection from the second camera origin through the second reference feature onto the common reference; and determining from the projection onto the common reference of the normal whether or not the first and second detected objected should be deemed to be labelled consistently.

Advantageously, embodiments of the present invention support identifying and consistently labelling the same object when viewed from different perspectives associated with respective cameras.

The precision or accuracy of consistently labelling an object across multiple fields of view having respective perspectives can be influenced by the predetermined metric. Embodiments comprise the predetermined metric being a measure of the distance between the first and second objects. Embodiments are provided wherein the distance corresponds to a distance between the projections of the features of the first and second objects

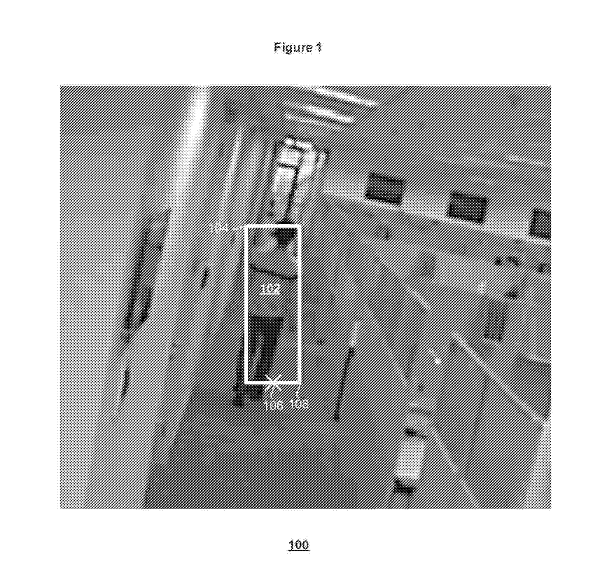

Referring to FIG. 1, there is shown an image plane 100 containing a detected object 102. In the present embodiment, the detected object is a person, but embodiments are not limited thereto. Embodiments can be realised in which the object of interest is any object, more particularly, any moving object. The detected object 102 is bounded by a bounding box 104. One skilled in the art readily appreciates how such a bounding box 104 can be used to identify a moving object within the image plane 100. For example, Background Subtraction (BGS) is a well known technique that can be used to segment or separate foreground objects from background objects.

The detected object 102 has a deemed position within the image plane 100. Embodiments of the present invention use the midpoint 106 of the lower edge 108 of the bounding box 104 as the detected object's 102 deemed position or location, known in the art as the footprint, within the image plane 100. Such an approach to determining the deemed position of a detected object 102 within the image plane 100 is particularly useful when the object to be detected is a person. One skilled in the art will realise that other methods of calculating the deemed position of an object within the image plane 100 can also be used, providing that such use is consistent.

The majority of prior art approaches to multi-camera tracking assume that correct-single camera tracking results are available through one or more BGS techniques. However, few BGS algorithms can determine an accurate object location.

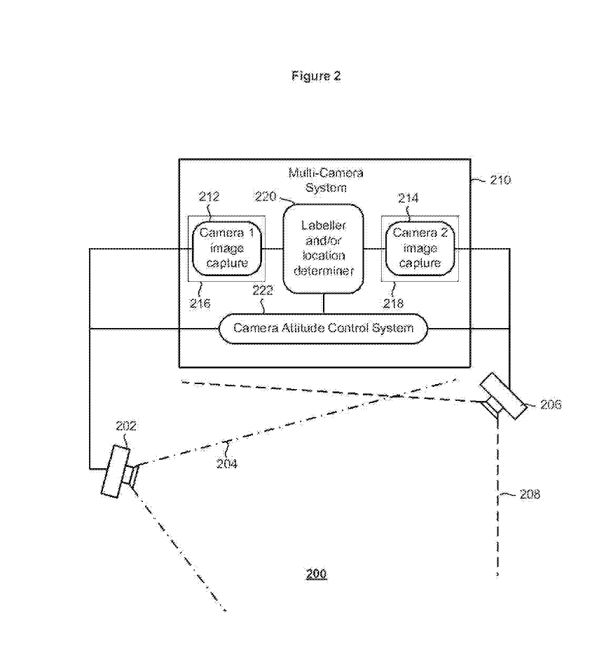

FIG. 2 shows a multi-camera system 200 comprising a first camera 202 that has a corresponding field of view 204. The first camera 202 will also have a corresponding first image plane associated with the first field of view 204. The system 200 also comprises a second camera 206 that also has a respective field of view 208. It can be appreciated that the cameras 202 and 206 survey a common volume, that is, their fields of view overlap. The cameras 202 and 206 are calibrated as is well known to those skilled in the art. Although the embodiment depicted uses two cameras, embodiments are not limited to such an arrangement. Embodiments can be realised in which two or some other number or plurality of cameras are used.

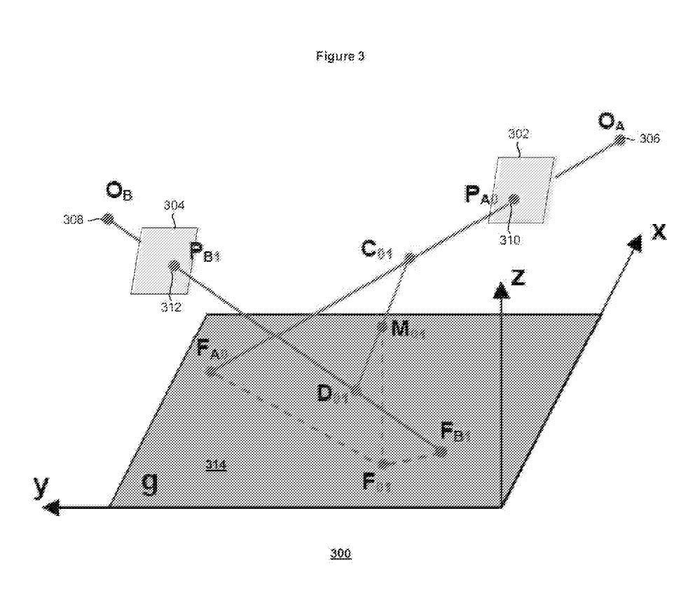

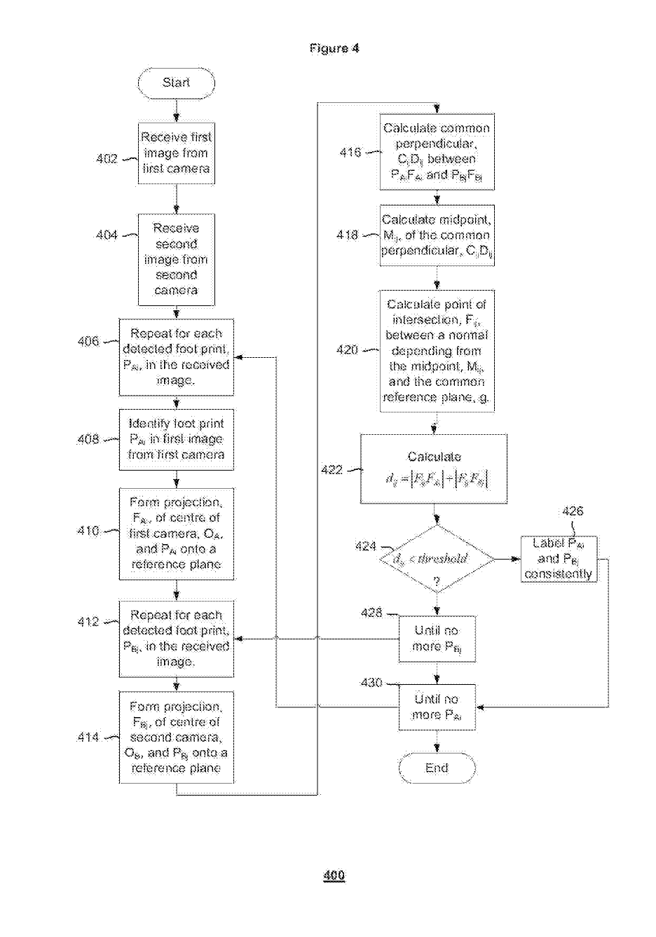

The multi-camera system 200 additionally comprises a data or image processing system or apparatus 210 for processing images 212 and 214 received from the plurality of cameras such as cameras 202 and 206. The images 212 and 214 are captured and stored using memory 216 and 218. A labeller 220 is used to process the images 212 and 214 to identify objects within each image and to determine whether or not any of those objects should have a common label. The processing undertaken by the labeller 220 will be described in greater detail with reference to FIGS. 3 and 4.

The multi-camera system 200 may additionally comprise a camera attitude control system 222 for controlling one or more parameters of the cameras 202 and 206.

Referring to FIG. 3, there is shown a first coordinate system 300. Embodiments can be realised in which the first coordinate system is a world coordinate system expressed in, for example, Cartesian coordinates. Although embodiments use Cartesian coordinates, other mathematical descriptions could be used such as, for example, quaternions. FIG. 3 shows an image plane 302 associated with the first camera 202 and an image plane 304 associated with the second camera 206. The first 202 and second 206 cameras have respective origins O_{A} 306 and O_{B} 308 also known as projection centres of the first 202 and second 206 cameras. Each image plane 302 and 304 comprises a detected foot print 310 and 312 or other predeterminable aspect of a detected object. The first coordinate system 300 comprises a common reference. In the embodiment described the common reference is a ground plane 314; the ground plane is also referred to as g. The equation of the ground plane 314 is z=0. Although embodiments use a ground plane having an equation of z=0 as the common reference, embodiments are not limited to such an arrangement. Embodiments can be realised in which some other reference such as, for example, some other reference plane having another equation is used.

As indicated above, the labeller 220 processes images received from the cameras 202 and 206 to identify the foot prints 310 and 312 of objects. F_{A0} is the projection of the foot print 310 in the first image plane 302 onto the common reference plane 314. F_{B1} is the projection of the foot print 312 in the second image plane 304 onto the common reference plane 314. C₀₁D₀₁ is the common perpendicular between lines P_{A0}F_{A0} and P_{B1}F_{B1}. M₀₁ is the midpoint of C₀₁D₀₁. F₀₁ is the projection of M₀₁ onto the common reference such as the ground plane 314.

Embodiments of the present invention model the detected objected as a line perpendicular to the common reference 314. In an ideal situation, one skilled in the art expects F_{0A} and F_{B1} to correspond to the same point. However, due to imperfections inherent in any system, such as, for example, imprecise camera calibration, geometric distortion and the imprecision with which foot prints can be determined, as well as the effect that gestures and differing attitudes can have, F_{0A} and F_{B1} rarely coincide; hence the skew lines P_{A0}F_{A0} and P_{B1}F_{B1}.

The labeller 220 is adapted to process a given image 302 from one camera 202, having a respective foot print 310, with a plurality of images taken from at least one further camera 206 with a view to determining whether or not the foot print 310 in the image 302 of the first camera 202 should be labelled consistently with one or more foot prints in the plurality of images of the second camera 206.

Without loss of generality, given any projective line such as for example, P_{A0}F_{A0}, the common perpendicular segment C₀ⱼD₀ⱼ between P_{A0}F_{A0} and each projective line P_{Bj}F_{Bj} is calculated, where

P_{Bj}F_{Bj} is the line formed by the projection of the jth foot print, P_{Bj}, of the image plane of the second camera onto the common reference 314, which is point F_{Bj}; and

C₀ⱼP₀ⱼ is(are0 the common perpendicular(s) associated with line P_{A0}F_{A0} and each of lines P_{Bj}F_{Bj}.

The midpoint, M₀ⱼ, of C₀ⱼD₀ⱼ is calculated and then the point of intersection of a normal from the point M₀ⱼ with the reference plane 314 is determined.

A predetermined metric or measure is evaluated with a view to determining whether or not the associated foot prints F_{A0} and F_{B0} correspond to objects that should be commonly labelled. Embodiments are provided in which the metric is d₀ⱼ=|F₀ⱼF_{A0}|+|F₀ⱼF_{Bj}|. If d₀ⱼ has a given relationship with a threshold, d, then the foot prints are assigned the same label. In preferred embodiments, if d₀ⱼ<d, where d is a predetermined threshold, then P_{A0} and P_{B1} are given the same label, that is, F_{A0} and F_{B1} are regarded as projections associated with the same detected object.

One skilled in the art will appreciate that neither F_{A0} nor F_{B1} can be taken as the real 3D location of the detected object within the coordinate system 300. Therefore, a further calculation is performed to provide an approximate position of the newly labelled detected object during a process called location correction.

Referring to FIG. 4 there is shown a flowchart 400 of a process for consistently labelling detected objects according to an embodiment.

A first image is received from a first camera 202 at step 402. A second image 206 is received from a second camera at step 404. A repeat-until construct is entered at step 406 where the processing is repeated for each detected foot print, P_{Ai}, in the first image. The ith foot print is the first camera image is identified at step 408. A projection from the centre, O_{A}, of the first camera through the ith foot print, P_{Ai}, to a common reference, g, is determined at step 410. A second repeat-until construct is entered at step 412, which processes all detected foot prints, P_{Bj}, within the second received image. The second repeat-until construct is arranged to perform a comparison between the current foot print of the first image and all foot prints of the second image with a view to determining whether or not any should be consistently labelled and actually labelling with a common label those foot prints that are deemed to correspond to the same detected object.

Step 414 forms a projection from the centre, O_{B}, of the second camera and the current foot print, P_{Bj}, of the second image onto the ground plane, g. A common perpendicular, CᵢⱼDᵢⱼ, is determined between skew lines P_{Ai}F_{Ai} and P_{Bj}F_{Bj} at step 416. The midpoint, Mᵢⱼ, of the common perpendicular is determined at step 418. The point of intersection, Fᵢⱼ, of a normal depending from the midpoint, Mᵢⱼ, of the common perpendicular with the reference plane, g, is determined at step 420. A metric associated with the reference plane projections is calculated as dᵢⱼ=|FᵢⱼF_{Ai}|+|FᵢⱼF_{Bj}| at step 422. A determination is made at step 424 regarding whether or not the metric is less than a predetermined threshold value. If the determination at step 424 is true, foot prints P_{Ai} and P_{Bj} are assigned, at step 426, a common label thereby indicating that they are deemed to be associated with the same detected object. If the determination at step 424 is false, processing continues from step 428 until all foot prints in the current second image have been processed. If all foot prints in the second current image have been processed, processing continues at step 430 until all foot prints in the first current image have been processed.

Once the above flowchart or processing has been performed, the foot prints of the corresponding detected objects in corresponding images of the first 202 and second 206 camera should have been consistently labelled.

It will be appreciated that the images processed by the system 200, such as the images 302 and 304, shown in FIG. 3 will be temporally concurrent images, that is, images captured substantially at the same time.

The above embodiments have been described with reference to determining whether or not a detected foot print of an object in an image associated with a given camera corresponds to foot prints of a plurality of images of a further camera. One skilled in the art will appreciate, however, that any given image might comprise one or more than one foot print. Each foot print or a selected plurality of foot prints of an image associated with a given camera should be processed against one or more foot prints of one or more images of the plurality of images of a further camera.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention. Accordingly, embodiments provide a program comprising code for implementing a system, device or method as described herein or as claimed herein and machine readable storage storing such a program. Still further, such programs may be conveyed electronically via any medium such as a communication signal carried over a wired or wireless connection and embodiments suitably encompass the same.

1. A data processing method comprising the steps of
receiving a first image from a first camera having a respective camera origin; receiving a second image from a second camera having a respective camera origin;
identifying a first reference feature of a first detected object within the first image; identifying a second reference feature of a second detected object within the second image;
forming a projection from the first camera origin through the first reference feature onto a common reference; forming a projection from the second camera origin through the second reference feature onto the common reference;
determining a projection onto the common reference of a normal depending from a midpoint of a common perpendicular between lines segments associated with projection from the first camera origin through the first reference feature onto the common reference and the projection from the second camera origin through the second reference feature onto the common reference; and
determining from the projection onto the common reference of the normal whether or not the first and second detected objected should be deemed to be labelled consistently.

2. A method as claimed in claim 1 wherein said determining from the projection onto the common reference of the normal whether or not the first and second detected objected should be deemed to be labelled consistently comprises calculating a predetermined metric associated with all of said projections onto the common reference, and determining whether or not that metric has a predetermined relationship with a threshold.

3. A method as claimed in claim 2 wherein said calculating the predetermined metric comprises calculating dᵢⱼ=|FᵢⱼF_{Ai}|+|FᵢⱼF_{Bj}|.

4. A method as claimed in any preceding claim in which the first and second images are correspond in time.

5. A system comprising memory for receiving first and second images associated with respective cameras; a determiner adapted to process the first and second images to identify respective objects depicted therein; the determiner being further adapted to calculate a predetermined metric associated with projections of the respective objects in a first frame of reference; and a labeller adapted to assign a common label to the objects according to the predetermined metric.

6. An apparatus comprising
a first receiver to receive a first image from a first camera having a respective camera origin; a second receiver to receive a second image from a second camera having a respective camera origin;
a first identifier to identify a first reference feature of a first detected object within the first image; a second identifying to identify a second reference feature of a second detected object within the second image;
a first projector to form a projection from the first camera origin through the first reference feature onto a common reference; a second projector to form a projection from the second camera origin through the second reference feature onto the common reference;
a first determiner to determine a projection onto the common reference of a normal depending from a midpoint of a common perpendicular between lines segments associated with projection from the first camera origin through the first reference feature onto the common reference and the projection from the second camera origin through the second reference feature onto the common reference; and
a second determiner to determine from the projection onto the common reference of the normal whether or not the first and second detected objected should be deemed to be labelled consistently.

7. An apparatus as claimed in claim 6 wherein said determiner to determine from the projection onto the common reference of the normal whether or not the first and second detected objected should be deemed to be labelled consistently comprises a calculator to calculate a predetermined metric associated with all of said projections onto the common reference, and means to determine whether or not that metric has a predetermined relationship with a threshold.

8. An apparatus as claimed in claim 7 wherein said calculator to calculate the predetermined metric comprises a processing element adapted to calculate dᵢⱼ=|FᵢⱼF_{Ai}|+|FᵢⱼF_{Bj}|.

9. An apparatus as claimed in any of claims 6 to 8 in which the first and second images correspond in time.

10. Machine executable instructions arranged, when executed, to implement a method, or an apparatus as claimed in any preceding claim.

11. Machine-readable storage storing a computer programme as claimed in claim 10.
